(19) United States
(12) Patent Application Publication
(10) Pub. No.: US 2007/0295201 A1
(43) Pub. Date: Dec. 27, 2007

(54) Control of Reciprocating Linear Machines

(76) Inventor: Michael William Dadd, Oxford (GB)

Correspondence Address: NIXON & VANDERHYE, PC, 901 NORTH GLEBE ROAD, 11TH FLOOR, ARLINGTON, VA, 22203, US

(21) Appl. No.: 11/630,788

(22) PCT Filed: Jun. 27, 2005
(86) PCT No.: PCT/GB05/02513

§ 371 Date: Jan. 18, 2007

(30) Foreign Application Priority Data
Jul. 5, 2004 (GB) 0415065.2

(51) Int. Cl. F15B 15/22

(52) U.S. Cl. 92/10

(57) ABSTRACT

An apparatus and method for controlling the offset and dynamics of a moving assembly in a reciprocating linear machine such as a linear compressor, heat pump or engine, comprises a gas spring connected to the moving assembly of the reciprocating linear machine and a pressure adjuster for adjusting the gas pressure in the gas spring. A position detector is provided for detecting the position of the moving assembly, either directly using a sensor, or from the drive to the moving assembly, and a controller controls the pressure adjuster in response to the detected position of the moving assembly. By adjusting the gas pressure the offset of the moving assembly can be controlled, and also the spring constant provided by the gas spring, and thus the resonant frequency of the assembly, can be adjusted.

The present invention relates to the control of reciprocating linear machines and in particular to the control of the position and dynamics of the moving assembly in such machines. Examples of such machines are linear compressors and pumps, engines, heat pumps and other similar machines which have a reciprocating moving assembly whose position is not well-constrained mechanically. The moving assembly in such machines may be the piston or the cylinder.

Linear compressors and expanders are of interest in a number of applications because of their ability to offer long life and high reliability with oil free-operation. Such applications include cryogenic coolers, Stirling engines and oil-free compressors. This linear technology however is not without its own problems and two aspects of particular importance are:
a) Control of moving assembly offset (mean position during reciprocation).
b) Control of machine dynamics.

In a conventional reciprocating compressor the mechanical power input into the compressor is in rotary form and is typically supplied by a rotary electric motor or a conventional internal combustion engine. The rotary motion is converted to a reciprocating motion of a piston by the use of some kind of mechanism—e.g. a crankshaft/connecting rod combination. The reciprocating movement of the piston in a cylinder can be used to compress/expand fluids in a number of ways and the energy flow from the compressor will show itself as a net flow of enthalpy in the fluid. This type of compressor has two features, which are advantageous:
1. The movement of the piston is defined only by the crank mechanism—it is independent of the pressure forces imposed on the piston by the fluid. Clearances at TDC and BDC can be minimal with no danger of a collision and this enables high volumetric efficiencies/compression ratios to be achieved.
2. The variation in the kinetic energy of the reciprocating component is readily and efficiently accommodated by small variations in the rotational energy of a flywheel—i.e. the rotary motor is required to produce only a constant torque and there is no dependence on frequency due to any resonant effect.

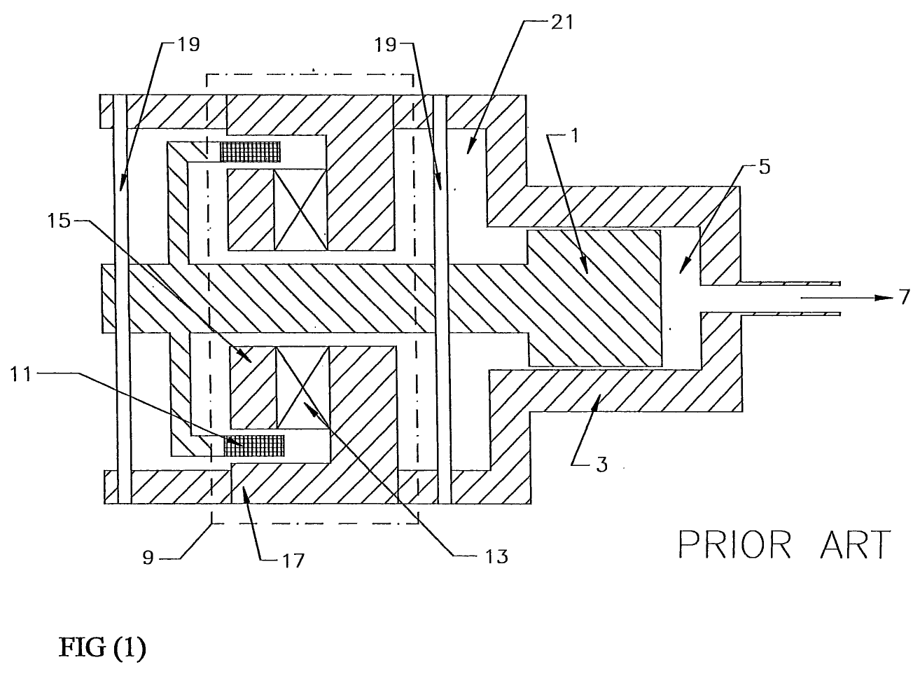

In contrast the power input to a linear compressor is generated by an oscillating force acting directly on the reciprocating moving assembly. Usually this force is electrically generated. FIG. 1 of the accompanying drawings schematically illustrates an example of a linear compressor of this type. The compressor comprises a working piston 1, constituting the moving assembly, which operates in a cylinder 3 to compress a working gas 5, compressed gas being available from the compressor outlet 7. The piston is driven by a linear motor 9 comprising an electrical coil 11 positioned in the air gap of a magnetic circuit formed by magnet 13 and inner and outer pole pieces 15, 17. The piston is suspended by means of suspension springs 19. Arrangements like this are typically used for small (power input 10-100 W) un-valved linear compressors used to power Stirling type cryocoolers.

Because a linear machine of this type lacks the crank mechanism and flywheel of a conventional compressor, some other means is required for: (1) taking up the variation of kinetic energy in an efficient manner; and (2) controlling the piston movement—both the stroke and mean position.

A preferred approach to taking up the variation in kinetic energy is to operate a linear compressor as a resonant oscillator, where there is a cyclic transfer of energy between the kinetic energy of the moving components and the stored energy of a spring. This arrangement is attractive because it is efficient: no force is required to maintain the motion other than that required by the work done in a cycle and so the load on the linear motor is the minimum it can be.

A requirement for resonant operation is that the moving mass, total spring constant and operating frequency be related by

$${ω}^{2} = \frac{k}{m} \qquad ω = 2 * π * operating frequency$$

where ω is angular velocity, k is the spring constant and m is the moving mass.

It will be seen that if the spring constant and mass are fixed then the operating frequency for resonance is also fixed.

The spring constant required for resonant operation generally has two components:
a) Most of the spring constant tends to be supplied by the spring component of the working gas 5 as it is compressed and expanded. This component will vary with the details of the working cycle.
b) “Solid” springs (e.g. suspension springs 19) are often incorporated in the construction of a linear compressor and these contribute a spring component that is fairly constant. (There are also machines with no “suspension springs” which are often referred to as “free piston” machines).

The stroke of the compressor is determined by the balance between the total work dissipated in the cycle (this includes useful work done on fluid plus losses) and work done by the motor 9. The work done on the fluid increases with stroke, so the stroke can be controlled by the varying power input to the linear motor 9.

The control of the mean piston position is more of a problem. As there is no geometric definition of the piston movement (as by a crank mechanism in a rotary machine), the piston assembly will drift until the mean force acting on it is zero. When the piston 1 is stationary leakage will ensure that the gas pressure on either side of the piston 1 will be equal and there will be no net gas force. The rest position of the piston 1 will therefore be the zero force position for the suspension springs 19. However, with the piston 1 compressing and expanding the gas, the mean gas pressure in the working space 5 will no longer equal the body pressure (the body pressure is the space 21 behind the piston) because of two effects:
a) The gas leakage past the piston 1 is not symmetrical and a steady state is only achieved when the mean working gas pressure is significantly lower than the body pressure.
b) The pressure waveform of the working gas is not symmetrical and its mean value will change as the magnitude of the working pressure changes.

The result is that there is a tendency for the gas forces to move the mean position of the moving assembly away from its rest position. The suspension springs 19 will oppose this effect, so the offset of the mean position will be determined by the relative magnitudes of the two forces. This offset can be reduced by increasing the proportion of the spring rate contributed by the suspension springs 19. In small machines this approach is often sufficient but in larger machines it becomes more difficult.

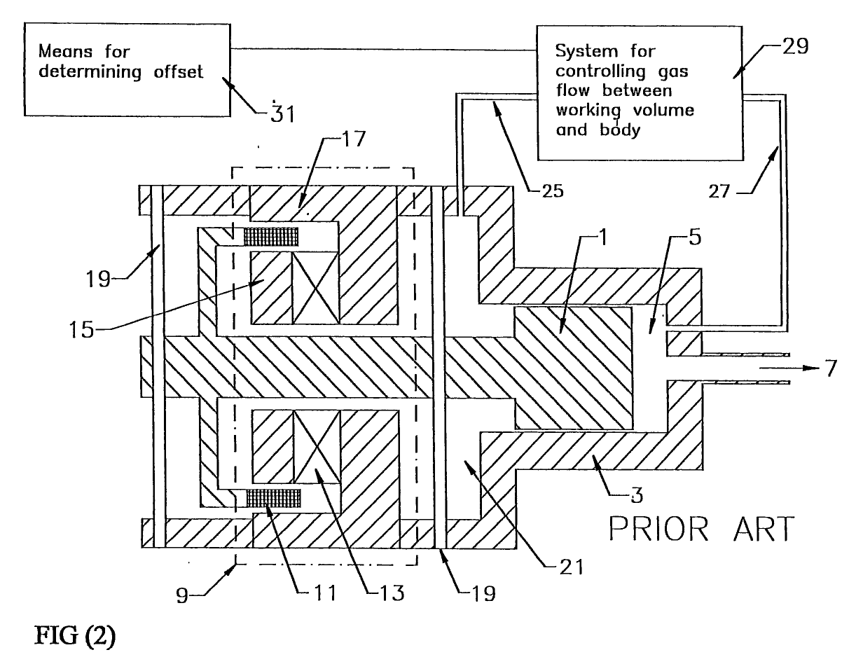

FIG. 2 of the accompanying drawings illustrates a compressor similar to that in FIG. 1 but in which an alternative way of controlling the piston offset is provided. In FIG. 2 the mean position of the piston 1 is controlled by equalising the mean gas pressures in the body space 21 and of the working gas 5 by means of pressure equalisation lines 25, 27 connected respectively to the body space and the working space which communicate by control valves in a controller 29 in response to a detector 31 for determining the piston offset. The piston offset may be detected using sensors, such as optical, magnetic (e.g. Hall effect) or electrical sensors, or by monitoring the voltage and current inputs to the electric motor.

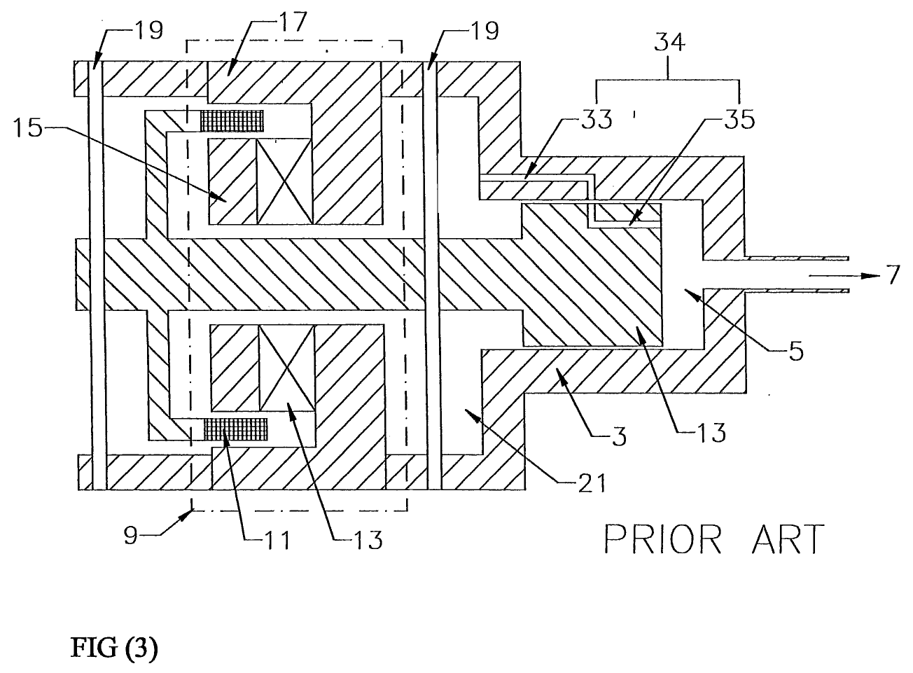

FIG. 3 shows a similar compressor in which equalisation of the pressures between the body space 21 and the working gas 5 is effected by the use of a ported valve 34 having one branch 33 through the compressor body and one branch 35 in the piston and which connect the body space and working space at a particular point in the piston movement when the two branches of the ported valve align (as illustrated in FIG. 3).

Such measures give the gas spring component of the working piston a defined zero position. Although leakage past the seal of the piston 1 may be asymmetric, the port 34 allows the gas to leak back so that the mean pressure at the defined zero point cannot deviate too far from the body pressure. The ports are therefore positioned so that the imposed zero point for the gas spring is the same as the zero point for the suspension springs 19.

However, such methods, although simple, tend to cause a reduction in the cycle efficiency of the compressor. For the pressure-volume loop of a typical compression cycle, the gas equalisation flows through the valve systems are across large enough pressure drops to cause a significant loss.

Further, the methods used to control offset that are described above for small machines become less suitable as size increases, and an additional issue arises: the operating pressure of the compressor body. It will be seen in FIGS. 1 to 3 that for the mean gas forces to balance, the body pressure needs to be equal to the mean working pressure which is typically fairly high ˜10 to 40 bar. For small sizes of machine, enclosing the entire compressor in a pressure vessel that can withstand the pressure is not a problem, as the wall thickness does not need to be very high. However for large machines the pressure vessel does become an issue as it can significantly add to both the weight and the cost. There is also a safety consideration—large pressure vessels have the potential to do a lot of damage if they fail and minimising the energy stored would be good practice. Also, pressure vessel regulations are stringent and so the extra cost involved would not be just in materials but would also be a result of the additional manufacturing control and inspection.

As mentioned above, as well as controlling the offset in linear machines, it is also desirable to be able to control the dynamic response of the machine.

For resonance to be achieved for a particular frequency a specific ratio of spring constant to moving mass is required. It will be appreciated that there will be a minimum value for the moving mass that can be achieved given the necessary components—e.g. motor armatures, pistons and connecting structures. Mass can, in principle, be added without limit, although it is clear that in many applications the less extra mass the better. As for spring constant, in almost all machines to date, which are mainly of small to medium size, the required spring stiffness has been achieved through a combination of the gas spring effect of the working gas and additional solid springs. The desired gas spring component is mainly obtained by setting the peak-to-peak pressure and manipulating the piston diameter and stroke. Final tuning can be made by adjusting the fill pressure (this in turn adjusts the peak to peak pressure). The solid spring component comes from the suspension springs 19 that control the linearity of the movement. Their contribution can be adjusted within limits but it is generally the case that as machine size increases, stroke also increases and the proportion of the spring constant that can be contributed by the suspension springs is reduced.

The problems described above occur in other reciprocating linear machines than compressors. Engines and heat pumps with free pistons or with pistons suspended in similar ways encounter the same problems.

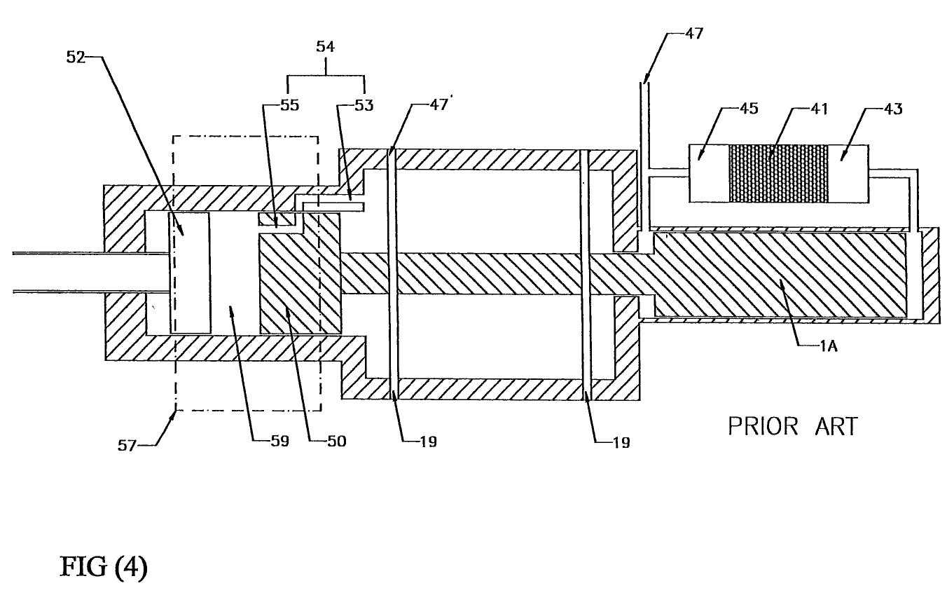

FIG. 4 of the accompanying drawings, for example, shows a Stirling cycle cooler in which a displacer 1a is used to move gas from the cold side 43 to the hot side 45 of a regenerator 41. The displacer is driven by a compressor connected to compressor connection 47 and may be suspended by suspension springs 19, though often Stirling cycle machines are free piston. A displacer is unlike a compressor piston in that it does not generate a volume variation. Thus the displacer does not contribute any significant gas spring effect, unlike the working piston in a compressor. To augment the spring stiffness provided by suspension springs 19, a gas spring 57 may be provided comprising a gas spring piston 50 which compresses gas in a gas spring compression space 59. The presence of the gas spring increasing the overall spring stiffness allows operation at a higher frequency. In Stirling cycle machines of this type, proposals have been made in the prior art to use ports and passageways as schematically illustrated at 54 in FIG. 4 to fix the mean gas spring pressure relative to the mean pressure of another volume in the machine (in this case the body pressure). As with the arrangements of FIGS. 2 and 3, the use of the ported valve 54 which connects the two spaces by means of branches 53 and 55, gives some control of the offset of the piston assembly. Alternatively, and as also illustrated in FIG. 4, the volume of the compression space of the gas spring can be varied by means of a separate piston 52. This changes the spring rate and thus the dynamic response of the piston assembly.

Thus with reciprocating linear machines, it is desirable to operate them reasonably close to resonance for good efficiency, but this is a problem if the machine is required to operate at a wide range of different working points as the resonance position varies. Furthermore, although various proposals have been made for controlling moving assembly offset and dynamics, they do not allow these properties to be defined with the precision possible in a conventional crank driven machine. These problems tend to become worse in larger sizes of machine, and they are inapplicable to all sizes of machine.

According to the present invention there is provided apparatus for controlling the position of a moving assembly in a reciprocating linear machine, comprising a gas spring connected to the moving assembly of the reciprocating linear machine, a pressure adjuster for adjusting the pressure of gas in the gas spring, a position detector for detecting the position of the moving assembly and outputting a position detection signal, and a controller for receiving the position detection signal and in response thereto controlling the pressure adjuster to adjust the pressure of gas in the gas spring thereby to control the position of the moving assembly.

Thus the invention provides an effective and adaptable way of controlling the offset of the moving assembly, such as the piston, in a linear machine. It is particularly suitable for use in larger sizes of machine (typically of 500 Watts or greater). Furthermore, because the control is by means of a dynamically adjustable gas spring, there is no need for the body space of the machine to be provided with a high pressure, thus reducing the problems associated with high pressures.

The gas spring may be a ported gas spring in which the port connects the gas spring compression space to the pressure adjuster. The port may extend through the gas spring piston and be connected to the pressure adjuster at one position of the stroke of the gas spring piston, for example the mid-stroke position.

The pressure adjuster may comprise a gas reservoir whose internal gas pressure is controlled by the controller, and it may have sources of high and/or low pressure gas so that its internal pressure can be adjusted.

The invention may be used to control the mean position of the moving assembly during reciprocation, but may also be used to control the dynamic response of the moving assembly during reciprocation. This may achieved by controlling the pressure adjuster to adjust the gas pressure in the compression space of the gas spring thereby to adjust the spring constant of the gas spring.

The moving assembly may be the piston in a moving piston machine or the cylinder in a fixed piston machine.

The invention is applicable to machines where the moving assembly is suspended by resilient solid springs or is free.

The gas spring may be separately provided, or provided stepped on the moving assembly of the reciprocating linear machine.

Two or more gas springs may be provided, of which at least one may be separate and at least one may be provided by a stepped spring. Preferably the different gas springs are provided with independent adjustment of the gas pressure in them. The pressure adjuster may be provided with separate gas reservoirs for each gas spring to provide the independent adjustment. The first and second gas springs may be provided with separate ports connecting them to the pressure adjuster.

The two gas springs may operate in opposition, for example by providing the second gas spring on the opposite side of a common gas spring piston, in the same cylinder as the first gas spring. However, separate gas springs may also work in opposition.

By adjusting the pressure in the gas compression spaces of the two gas springs, the difference in pressure between them may be used to control the mean position of the moving assembly and the sum of the pressures may be used to control the spring constant.

The invention extends to a corresponding method of controlling a moving assembly in a reciprocating linear machine and to a linear machine which incorporates such apparatus operating in accordance with the method.

Examples of linear machines to which the invention may be applied are compressors, heat pumps and engines. A linear drive such as an electric linear motor may be used to drive the compressor or heat pump and, in the case of a compressor, compressed gas from the compressor may be used to supply the pressure adjuster. In the case of an engine, the engine may drive a compressor for supply of compressed gas to the pressure adjuster.

The invention is also applicable to the control of position of the displacer in a Stirling cycle machine.

The invention will be further described by way of non-limitative example with reference to the accompanying drawings in which:—

FIG. 1 schematically illustrates a prior art linear compressor;

FIG. 2 schematically illustrates a similar prior art linear compressor utilising pressure equalisation to control piston offset;

FIG. 3 schematically illustrates a prior art linear compressor utilising a ported working piston for pressure equalisation;

FIG. 4 schematically illustrates a Stirling cycle cooler with different methods of piston control;

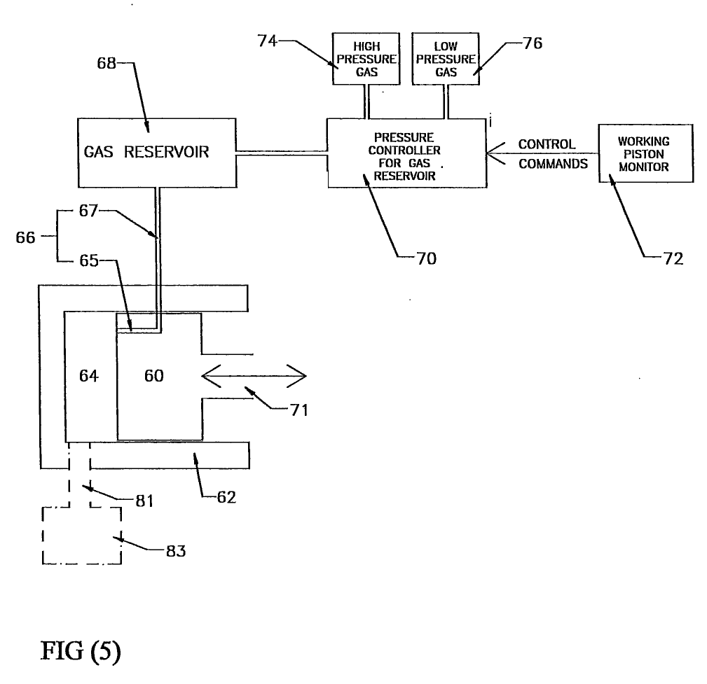

FIG. 5 schematically illustrates a first embodiment of the present invention;

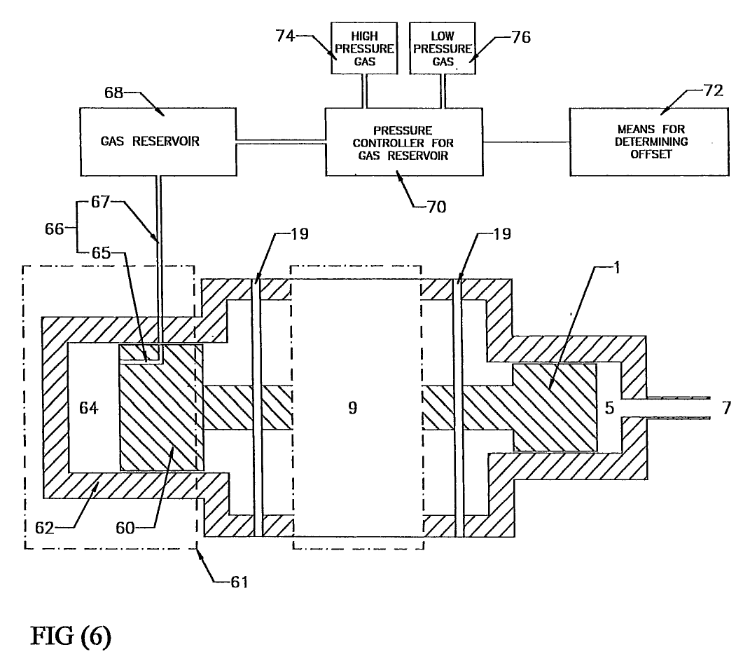

FIG. 6 schematically illustrates the application of the first embodiment of the present invention to a linear compressor;

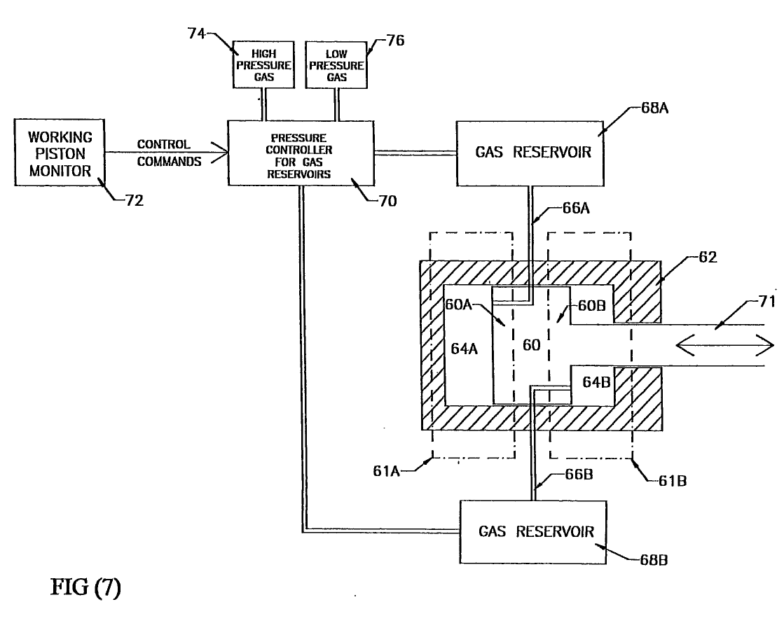

FIG. 7 schematically illustrates a second embodiment of the present invention;

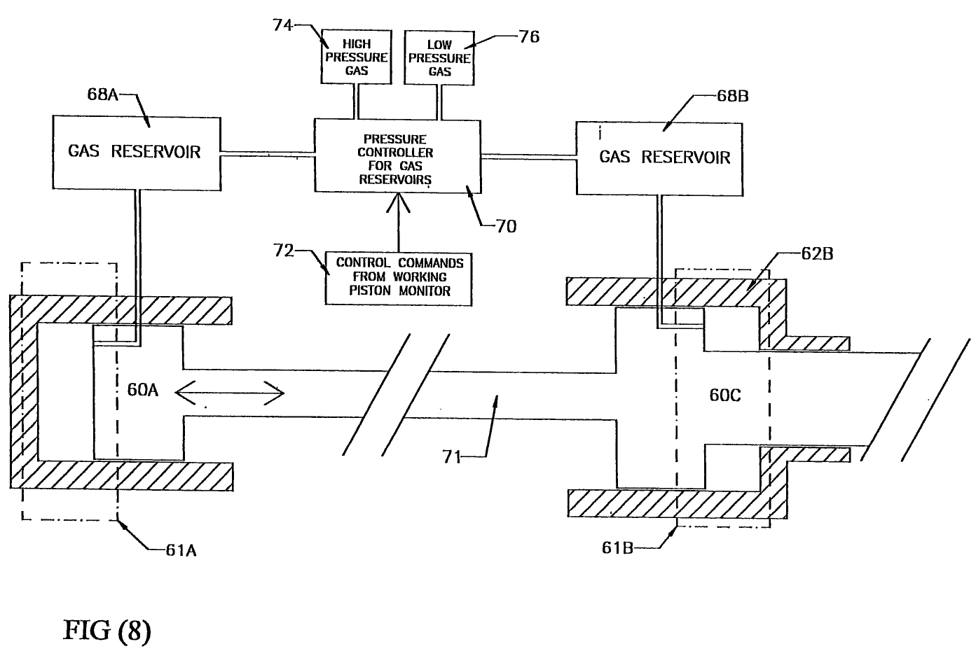

FIG. 8 schematically illustrates a third embodiment of the present invention;

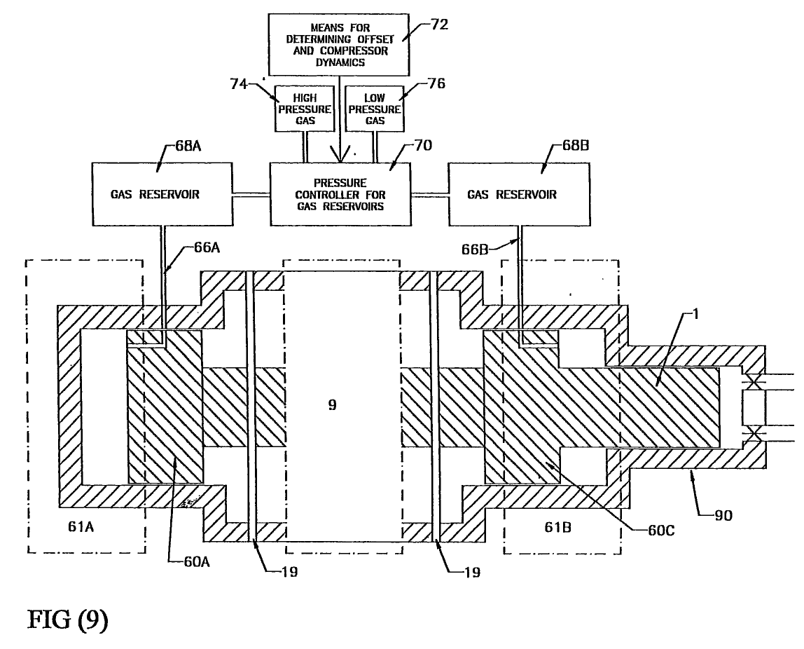

FIG. 9 schematically illustrates a fourth embodiment of the present invention; and

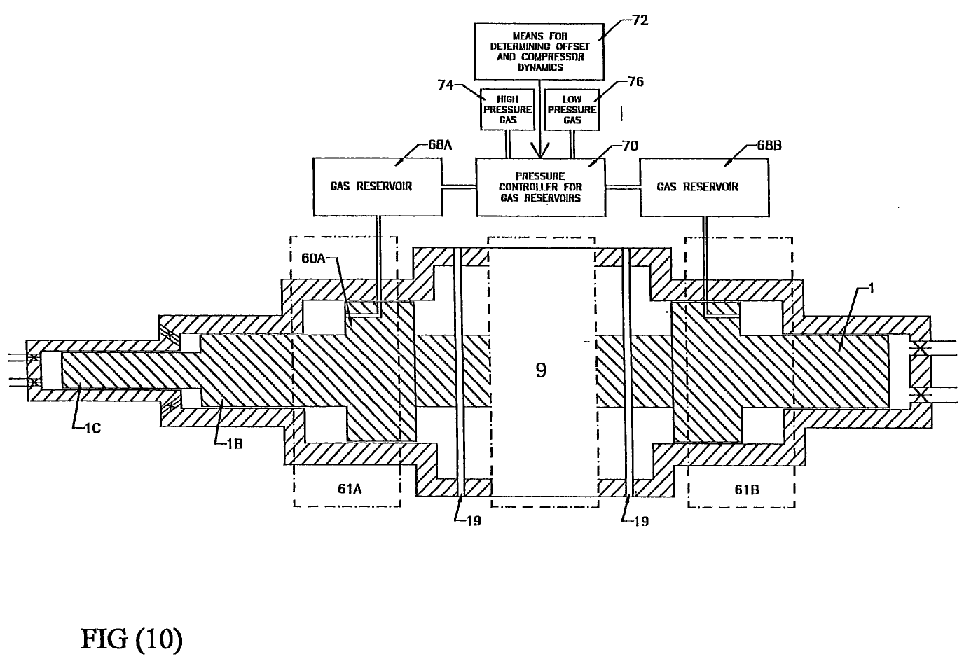

FIG. 10 schematically illustrates a fifth embodiment of the present invention.

As illustrated schematically in FIG. 5 a first embodiment of the invention comprises a gas spring which has a gas spring piston 60 in a gas spring cylinder 62. The gas spring piston 60 is moveable within the cylinder 62 and is attached by shaft 71 to the rest of the moving components of the reciprocating linear machine (not shown in FIG. 5). The cylinder is closed at one end to form a gas spring compression space 64. The gas spring piston 60 is, as is conventional, provided with piston seals (not illustrated) for controlling gas leakage. The gas spring compression space 64 is connected by means of port 66 to a gas reservoir 68. The port 66 comprises a first branch 65 through the gas spring piston 60 and a second branch 67 extending through the cylinder and connected with the gas reservoir 68. The two branches are connected at one point of the movement of the gas spring piston, in practice approximately at the required mid-stroke position. The pressure in the gas reservoir 68 is independent of the pressures elsewhere in the machine and is set by a controller 70 which receives control signals from a working piston position detector 72 and supplies either high or low pressure gas to the gas reservoir from a high pressure gas supply 74 and low pressure gas supply 76 as required to adjust pressure in the gas reservoir.

Thus when the gas spring piston is at the mid-stroke position such that the two branches of the port 66 communicate, the gas pressure in the gas spring compression space 64 tends to equalise with the pressure in the gas reservoir 68. In this way the reservoir pressure is used to control the mean pressure of the gas spring.

The gas in the gas spring compression 64 exerts a mean force on the gas spring piston 60 which is determined by the mean gas spring pressure and the area of the piston 60. The gas spring also contributes a spring constant which is determined by the mean gas pressure, the area of the piston 60 and the volume of the gas spring compression space. Varying the reservoir pressure thus varies both the mean force on the gas spring piston 60 and the spring constant.

The gas spring compression volume 64 can be augmented by the addition of one or more extra volumes 83 that are connected by suitably dimensioned passageways 81 to the volume 64. The flow area of the passageway 81 is specified such that the pressure drop is negligible for flow between the compression space 64 and the additional volume 83.

The provision of extra volumes allows the total compression volume to be made large compared with the swept volume of the gas spring. The variation in gas spring pressure with movement of the gas spring piston is then small and the spring constant generated is also small. In this way a ported gas spring can be used such that a large mean force is accompanied by only a small gas spring constant. If the total spring constant is dominated by other components, changes in the mean force can be effected with little change to the total spring constant.

FIG. 6 illustrates the application of the gas spring 61 of FIG. 5 to a linear compressor. The gas spring is mounted at the opposite end of the moving assembly from the single working piston 1. In the nominal operating state the moving assembly is centred (i.e. the offset is set to zero) and the mean force acting on the gas spring piston 60 is equal to the mean force acting on the working piston 1. If the working piston monitor 72 detects that the moving assembly is drifting from the intended mean position, then the controller 70 varies the mean gas spring force by use of the gas reservoir 68 and high and low pressure gas supply 74 and 76 to counter this effect.

The working piston monitor 72 is of the conventional type and may comprise sensors for directly sensing the working piston position (for instance magnetic, electrical or optical sensors), or may be based on analysing the current and voltage in the electric linear motor 9.

FIG. 7 illustrates a second embodiment of the invention in which a single gas spring piston 60 is used in a double acting arrangement with two ported gas springs 61a and 61b acting on it. The first gas spring 61a is the same as that in FIGS. 5 and 6, whereas the second gas spring 61b is formed by the opposite side 60b of the piston 60 which compresses gas trapped in the cylinder 62 by the seal to the shaft 71. This creates a second gas spring 61b with a second gas spring compression space 64b. The effective piston area of the second gas spring is somewhat less than the first, but this does not significantly affect operation. As illustrated in FIG. 7 the second gas spring is provided with a second gas reservoir 68b connected by a port 66b to the second gas spring compression space 64b. The controller 70 can therefore independently adjust the pressure in the two gas springs. Because the ports 66a and 66b to the two gas springs both need to be at the mid-stroke position, they are separated by different angular orientations in the cylinder.

In the arrangement in FIG. 7 the forces imparted to the gas spring piston 60 are in opposition to each other so that the net force will be the difference between the two mean forces resulting from gas spring compression spaces 64a and 64b. The spring constants for the two gas springs, however, add to give a total spring force. This means that the offset and dynamic response of the linear machine to which the gas spring is connected can be independently controlled by varying independently the difference between the two pressures and the sum of the pressures. The spring constant can be increased by increasing the sum of the pressures, while keeping the offset the same by maintaining the same difference between the gas pressures. On the other hand, the difference between the gas pressures can be adjusted to adjust the offset, while keeping the sum of the pressures the same to maintain the same spring force.

FIG. 8 schematically illustrates a third embodiment of the invention in which two gas springs 61a and 61b are provided, but in which the second gas spring 61b is formed as a stepped piston 60c moving in a second cylinder 62b.

FIG. 9 illustrates the application of the embodiment of FIG. 8 to the control of the offset and machine dynamics in a single staged valved compressor. The second gas spring 61b is formed by the stepped piston 60c which is provided adjacent to the working piston 1. The first gas spring is a separate piston/cylinder assembly 61a mounted at the other end of the moving assembly. The first gas spring 61a balances the forces of both the working piston 1 and the second gas spring 61b. The use of the invention removes the need to set the body pressure of the machine to a specific value, instead the gas spring pressures are used to control the offset and dynamics of the compressor.

FIG. 10 schematically illustrates a three stage valved compressor which is similar to the compressor illustrated in FIG. 9 but the first gas spring 61a is provided on a stepped piston which also carries a second working piston 1b which is a stepped piston and a third working piston 1c. Thus compressed gas is produced from both ends of the assembly.

In the embodiments above the information generated by the monitoring system 72 is used to calculate the pressures in the gas reservoirs 68, 68a, 68b for ideal running and the controller 70 is used to adjust continually the reservoir(s) pressure so as to achieve this. For example, if the moving assembly is drifting one way (the offset is changing), but the dynamics are correct, then the controller 70 acts to increase the pressure in one gas spring while reducing it in the other. In this way the spring rate is unchanged but the required restoring force is generated. Alternatively, if the mean position is correct but the total spring stiffness is too small (resulting in operation too far from resonance) then the gas pressure can be increased in both springs to increase the spring constant. The pressures need to be adjusted in the appropriate ratio, as determined by the piston areas, in order that the offset is not changed when the gas pressures are changed.

The illustrated supplies of low pressure and high pressure gas may easily be obtained when the invention is applied to a linear compressor as they may be tapped off from the various pressure levels generated by the compressor itself. For other machines, or for unvalved compressors, these low and high pressure supplies are not necessarily available and must be specifically provided. One method is to use a separate valved compressor purely for this function. The invention is applicable to machines of varying sizes, including both small and large. The sizing of the gas spring pistons is determined by the range of mean force and spring constant required for the forseeable operating conditions and the control pressure available.

1. Apparatus for controlling the position of a moving assembly in a reciprocating linear machine, comprising a gas spring connected to the moving assembly of the reciprocating linear machine, a pressure adjuster for adjusting the pressure of gas in the gas spring, a position detector for detecting the position of the moving assembly and outputting a position detection signal, and a controller for receiving the position detection signal and in response thereto controlling the pressure adjuster to adjust the pressure of gas in the gas spring thereby to control the position of the moving assembly.

2. Apparatus according to claim 1 wherein the gas spring is a ported gas spring having a port connecting the gas spring compression space to the pressure adjuster.

3. Apparatus according to claim 2 wherein the port extends through the gas spring piston of the gas spring.

4. Apparatus according to claim 3 wherein the port is connected to the adjuster at one position of the stroke of the gas spring piston.

5. Apparatus according to claim 4 wherein said one position is the mid-stroke position.

6. Apparatus according to claim 1 wherein the pressure adjuster comprises a gas reservoir whose internal gas pressure is controlled by the controller.

7. Apparatus according to claim 1 wherein the pressure adjuster comprises sources of at least one of high and low pressure gas.

8. Apparatus according to claim 1 wherein the aspect of position of the moving assembly which is controlled is the mean position during reciprocation.

9. Apparatus according to claim 1 wherein the controller is adapted to control the dynamic response of the moving assembly during reciprocation by means of the pressure adjuster.

10. Apparatus according to claim 1 wherein the controller is adapted to control the dynamic response of the moving assembly during reciprocation by controlling the pressure adjuster to adjust the gas pressure in the compression space of the gas spring thereby to adjust the spring constant of the gas spring.

11. Apparatus according to claim 1 wherein the moving assembly is suspended for linear reciprocation by resilient springs.

12. Apparatus according to claim 1 wherein the gas spring is stepped on the moving assembly of the reciprocating linear machine.

13. Apparatus according to claim 1 wherein two opposed gas springs are provided, and said pressure adjuster provides independent adjustment of the gas pressure in the gas spring.

14. Apparatus according to claim 13 wherein the pressure adjuster comprises a separate gas reservoir for each gas spring.

15. Apparatus according to claim 13 wherein the second gas spring is provided on the opposite side of a common gas spring piston in same cylinder as the first gas spring.

16. Apparatus according to claim 15 wherein each of the first and second gas springs are provided with separate ports connecting them to the pressure adjuster.

17. Apparatus according to claim 13 wherein the second gas spring is a stepped piston on the moving assembly of the reciprocating linear machine.

18. Apparatus according to claim 1 wherein the reciprocating linear machine comprises two or more working pistons as said moving assembly, at least one having said gas spring formed thereon by a stepped piston.

19. A reciprocating linear machine comprising apparatus according to claim 1.

20. A reciprocating linear machine according to claim 19 wherein the machine is a compressor.

21. A reciprocating linear machine according to claim 20 wherein the pressure adjuster receives compressed gas from the compressor for use in controlling the pressure of the gas spring.

22. A reciprocating linear machine according to claim 19 wherein the machine is a heat pump.

23. A reciprocating linear machine according to claim 20, further comprising a linear drive for driving the compressor or heat pump.

24. A reciprocating linear machine according to claim 23 wherein the linear drive is a linear electric motor.

25. A reciprocating linear machine according to claim 19 wherein the machine is an engine.

26. A reciprocating linear machine according to claim 25 wherein the engine drives a compressor for supply of compressed gas to the pressure adjuster.

27. A reciprocating linear machine according to claim 19 wherein the moving assembly is a displacer in a Stirling cycle machine.

28. A method of controlling the position of a moving assembly in a reciprocating linear machine comprising monitoring the position of the moving assembly and in response thereto dynamically adjusting the pressure in the gas compression space of a gas spring connected to the moving assembly.

29. A method according to claim 28 wherein the aspect of position of the moving assembly which is controlled is the mean position during reciprocation.

30. A method according to claim 28 comprising the step of dynamically adjusting the pressure in the gas compression space of the gas spring connected to the moving assembly to control the dynamics of the moving assembly.

31. A method according to claim 28, wherein the pressure in the gas compression space of the gas spring is adjusted to control the spring constant of the gas spring.

32. A method according to claim 28 comprising the step of independently dynamically adjusting the pressure in the gas compression spaces of two gas springs connected to the moving assembly.

33. A method according to claim 32 wherein the mean position of the moving assembly is controlled by adjusting the difference in pressure between the gas compression spaces of the two gas springs.

34. A method according to claim 32 wherein the spring constant of the two gas springs is controlled by adjusting the sum of the pressures in the gas compression spaces of the two gas springs.

35. Apparatus according to claim 1, wherein the moving assembly is a working piston of the reciprocating linear machine.

36. A reciprocating linear machine according to claim 19 wherein the moving assembly is a working piston of the reciprocating linear machine.

37. A method according to claim 28 wherein the moving assembly is a working piston of the reciprocating linear machine.
